(19) United States
(12) Patent Application Publication
(10) Pub. No.: US 2007/0129957 A1
(43) Pub. Date: Jun. 7, 2007

(54) Mail piece verification system and method

(75) Inventors: Sarah A. Elliott, Towson, MD (US); Mark G. Paul, Raleigh, NC (US); Roger Spitzig, St. Clements (CA); Mark Van Gorp, Cary, NC (US)

Correspondence Address: MCDERMOTT WILL & EMERY LLP, 600 13TH STREET, N.W., WASHINGTON, DC, 20005-3096, US

(73) Assignee: BOWE BELL + HOWELL COMPANY

(21) Appl. No.: 11/592,164

(22) Filed: Nov. 3, 2006

Related U.S. Application Data
(60) Provisional application No. 60/742,569, filed on Dec. 6, 2005.

(51) Int. Cl. G06F 17/00; G06Q 99/00

(52) U.S. Cl. 705/1; 705/408

(57) ABSTRACT

An image-based verification system integrates with mail finishing equipment, such as an inserter, in much the same way as a postage meter. The verification system registers individual mail pieces as they are processed and dynamically builds a postage summary report to accompany mail when it is sent to the post office for delivery. The verification system is configured with the various weights and associated postage rates required, so variable weight mailings can be processed with only one device per inserter. Postage due is paid using a mailing permit, which is printed on the envelope and may include a date. The verification system provides greater protection for both the mailer and postal authority, as production data is not generated into a report until after mail post-processing as opposed to generating reports based on pre-processing data.

### RELATED APPLICATIONS

This application claims the benefit of U.S. Provisional Application No. 60/742,569, filed on Dec. 6, 2005, entitled “Verification Appliance”, the disclosure of which is entirely incorporated herein by reference.

### TECHNICAL FIELD

A method and a system are provided for verifying mail pieces during processing, and more particularly a method and system are provided for registering individual mail pieces during mail processing, such as inserting, and dynamically generating documentation to accompany the mail destined for a postal authority for delivery.

### BACKGROUND

Mailers have options when deciding how to pay for postage. The postal authority (e.g. the United States postal Service—USPS) currently offers three choices:
Pre-canceled stamps—Special stamps are purchased at a low postage rate (say, 10 cents); difference in postage is paid when mail is delivered to the post office.
Postage meters—Printing postage directly onto a mail piece using a rented device. Postage on meters is just like cash; it must be accounted for using a mail management system and, once printed on an envelope, has real value that may not be 100% reclaimable if the envelope is damaged.
Permit imprints—Paying postage using a mailing permit by printing a block of information (e.g. “indicia” which include the mailer's permit number) in the upper right corner of each mailpiece. When presented to the USPS, mail marked with permits must be accompanied by a report listing what is contained in the mailing. The indicia are used to identify mail submitted by that mailer. Postage due is paid at time of mailing.

Mailers can choose to use any one or all three of these methods depending on their operation and the characteristics of their mailings. Earned postal discounts are not affected by the postage payment method.

Paying with a permit is routinely recognized as the most cost-effective method, especially in light of the expense and effort required to migrate to digital meters, and the fact that even digital meters can jam or bottleneck high-speed finishing equipment, causing an overall reduction in throughput and productivity. However, even in light of obvious advantages to using permits to pay for postage, many mailers hesitate to make the conversion.

Traditional ‘business’ permit mailing requires every mail piece to be identical in weight so each mail tray can be weighed and divided by the weight of the piece to determine the number of items in the tray. The number of pieces is multiplied by the rate to determine postage due. This method is most often used for standard class mail, where there is no variation between documents. Permit mailing of first class mail, which can vary widely in page count from document to document, is most often processed using manifest mailing procedures, in which postage due is calculated and reported for each piece individually.

Hence a need exists for a verification system that can be connected to a mail processing system, such as an inserter, that will provide the ease of use associated with a meter system while building the documentation necessary for submitting a permit mailing to the postal authority. At the same time, the necessary verification of each mail piece processed will enhance accuracy of the calculation of postage due at the time the mail is submitted and provide the data necessary for the postal authority to audit the physical mail versus the documentation provided.

### SUMMARY

One aspect of the present claimed subject matter includes a system for verifying a mailing including a plurality of mail pieces. The verifying system includes an image capturing device for acquiring image data associated with each mail piece processed by a document processing system. A processor is included for processing the acquired image data. The processor has one or more channels for receiving weight category data of each mail piece. A user interface is included and is for enabling user control of the processor. The user interface conveys control functions and features required for the generation of a permit mailing. The processor is adapted to generate a postal authority mailing report conveying data associated with each mail piece included in the mailing. The conveyed data is based at least in part on an interpretation of the image data.

In certain aspects, a method of verifying an amount of postage to be applied to one or more mail pieces in the absence of a postage meter is provided. The method includes capturing image data for the one or more mail pieces as the one or more mail pieces is processed by a document processing system. The weight category is associated with the image data captured from the one or more mail pieces. A mail report is generated and the report conveys at least information usable by a postal authority for verifying a postage amount due as a result of processing of the one or more mail pieces. The verification is based at least in part on an interpretation of the image data and the associated weight category data.

In yet another aspect is a method which includes processing one or more mail pieces. The method includes applying indicia to the mail piece as it is processed by a document processing system. Image data is captured for the mail piece as the mail piece is processed by the document processing system. Weight category data is associated with the image data captured for the mail piece. Information extracted from the captured image data and the associated weight category data is conveyed and corresponds to the mail piece processed by the document processing system.

It is also desirable to provide a method for generating a mail report. The method includes capturing image data associated with one or more mail pieces as the mail piece is processed by a document processing system. Weight category data is associated with the image data captured for the mail piece. A mail report is generated and conveys data including at least the associated weight category and a postage amount due for a mail piece with respect to a mail piece identifier associated with the mail piece. The mail report is provided to the postal authority or operator of the document processing system.

In yet another aspect a method for generating reports based on the processing of a plurality of mail pieces by a plurality of document processing devices is provided. The plurality of mail pieces are part of a complete mailing. The method comprises capturing image data associated with each of the plurality of mail pieces as each mail piece is processed by a respective document processing system. Weight category data is associated with the image data captured for each of the plurality of mail pieces. The method includes the step of generating in association with each respective document processing system a mail report conveying data including at least the associated weight category and a postage amount due for each of the plurality of mail pieces with respect to a mail piece identifier associated with each of the plurality of mail pieces. Each respective mail report is aggregated to create a final mail report. The final mail report conveys data representative of the complete mailing.

Other aspects and advantages of the present disclosure will become apparent to those skilled in this art from the following description of preferred aspects taken in conjunction with the accompanying drawings. As will be realized, the disclosed concepts are capable of other and different embodiments, and its details are capable of modifications in various obvious respects, all without departing from the spirit thereof. Accordingly, the drawings, disclosed aspects, and description are to be regarded as illustrative in nature, and not as restrictive.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exemplary functional block diagram of the overall mail flow, depicting an example of verification system integrated into an inserting mailing system to create a permit mailing in accordance with postal authority postage payment and mail acceptance requirements;

FIG. 2 depicts the current art that requires the use of postage meters for postage payment;

FIG. 3 diagrams the technique used to calculate the weight of a mail piece based on the contents of the envelope;

FIG. 4 shows an exemplary decision tree for how the reports and electronic files may be created for the postal authority;

FIG. 5 depicts the exemplary processing steps performed by the verification system and the verification computer;

FIG. 6 shows the exemplary operation of multiple verification systems as they are networked to enable a mailing to be processed on multiple inserting machines;

FIG. 7 depicts the exemplary imaging and computing functions of the verification system and the detached verification system;

FIG. 8 depicts the exemplary data content that may be provided to the postal authority by the verification system;

FIG. 9 shows the exemplary system configuration for advanced quality tracking and advanced postal reporting;

FIG. 10 is a functional flow of the system steps from print processing through tray tag verification;

FIG. 11 defines the error correction options;

FIG. 12 defines the steps required for the verification system to create final postal authority reports without input from the data center processor; and

FIG. 13 defines the mail acceptance process.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The verification system described herein provides the capabilities necessary to allow mailers to use permit indicia, instead of a meter mark, to pay postage. The verification system includes an image capturing system, an interface to receive weight category data, connection to a dedicated or shared user interface, a dedicated or shared processor that is directly connected or network connected to the various verification system components, communication interfaces to various processors in the document factory, communications to the document processing system and communication interfaces to external locations such as a postal authority. Numerous configurations are possible for the verification system, depending on the preferred design features as architected by those skilled in the art. At least the image capture system needs to be attached to the document processing system. The other components and interfaces may be local or remotely located and connected. One example could include one processing system that would be interfaced to numerous image capturing systems using a network. The other interfaces indicated above would also be network connected to a processor. The processor could be located on site at the document factory of remotely hosted at a distant location. The verification system provides for the secure, accurate collection of data, e.g. to provide total piece count, piece weight, destination ZIP, and date and time of processing and numerous other parameters desired by the document factory operations or by postal authorities.

The disclosed verification system is a self-contained, independent system that can be added to any mail processing equipment, regardless of age, vendor or intelligence such as document tracking and insert control. No Information Technology (IT) specialist involvement is required to implement the verification system, as the system does not connect to a data center processor or require information other than the delivery address to be visible on the exterior of the envelope. Neither is an integrity control file necessary, since the verification system generates an accurate report of items detected, which can be compared with the postage summary report for the mailing.

The exemplary verification system accelerates the postal authority “connected” vision for electronic documentation by providing electronic files that comply with postal authority standards. The verification system achieves inline verification of every mail piece to improve mail quality and reduce mailer postage and production costs. Optionally, the verification system can perform quality checks on every mail piece, such as verifying the presence of a delivery address and postage payment marks; evaluating the readability and placement of POSTNET; and validating that the ZIP matches data in the POSTNET barcode. As a result of collecting and reporting on this data, and of performing these quality checks, the postal authority has added assurance that earned automation discounts are justified and the mailer can better predict the successful acceptance of their mail. In addition, the verification system can provide secure data to postal authority electronically via formats such as the USPS mail.dat format, or produce “hard copies” of standard reports.

The disclosed verification system provides a higher level of revenue protection for both the mailer and postal authority, as production data is not supplied until after mail has been finished and is ready for delivery. In contrast, many mailers who meter today submit their mail and pay postage due based on documentation that was generated at the same time as the pre-print data file. Items may be damaged beyond repair during the printing or finishing processes or be culled from the mailing due to numerous reasons such as removing dunning notices when no longer required. Failure to accurately report these missing pieces—whether deliberately or unintentionally—means the mailer is either under- or over-paying for a mailing. By providing information about every item in a mailing, the verification system gives the postal authority the added assurance that the postage paid is complete. And by making this information available to the mailer prior to depositing mail with the postal authority, the mailer has the opportunity to remedy any issues and avoid paying fees that would be assessed if errors are detected during the postal authority acceptance process. Additionally, by providing information in electronic format, the reconciliation process for both the mailer and postal authority is more accurate and requires significantly less effort than manual reporting.

The present verification system integrates directly with finishing equipment in much the same way as postage meters do today. Designed to look and behave like a meter from the perspective of the finishing equipment, this solution registers individual mail pieces as they are processed and dynamically builds a postage summary report to accompany mail when it is sent to the post office for delivery. The verification system is configured with the various weights and associated postage rates required, so variable weight mailings can be processed with only one device per inserter. Postage due is paid using a mailing permit, which must be printed on the envelope and may include a date. Using the verification system, mailers can take advantage of the benefits of permit mailing with little or no changes to the way mail is processed today.

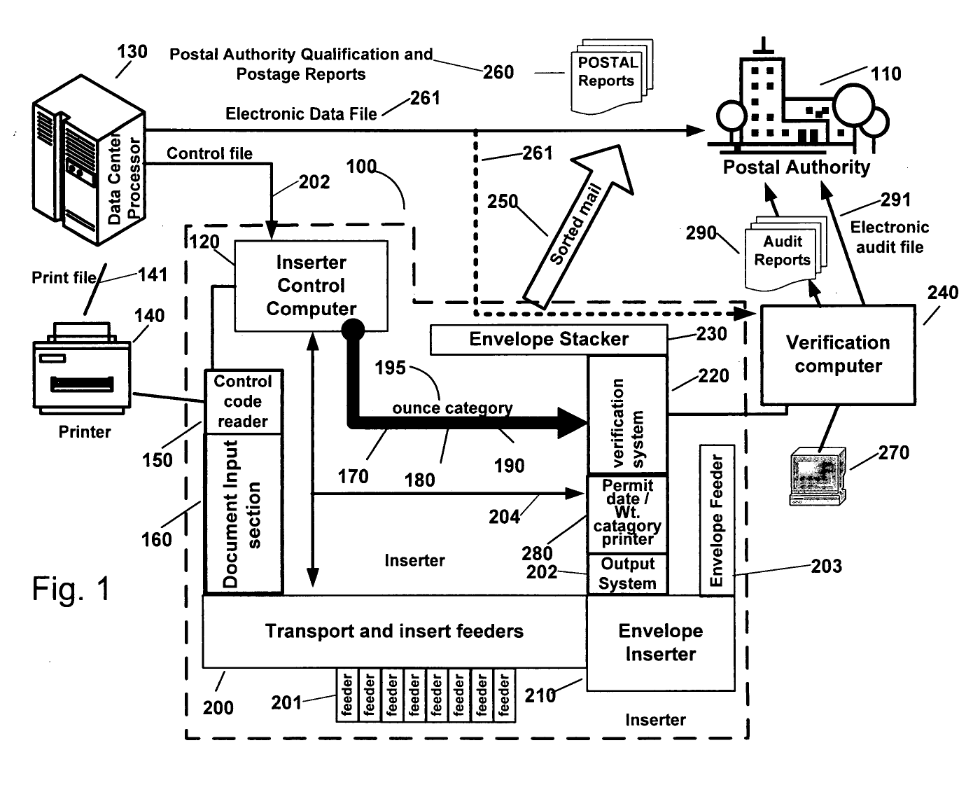

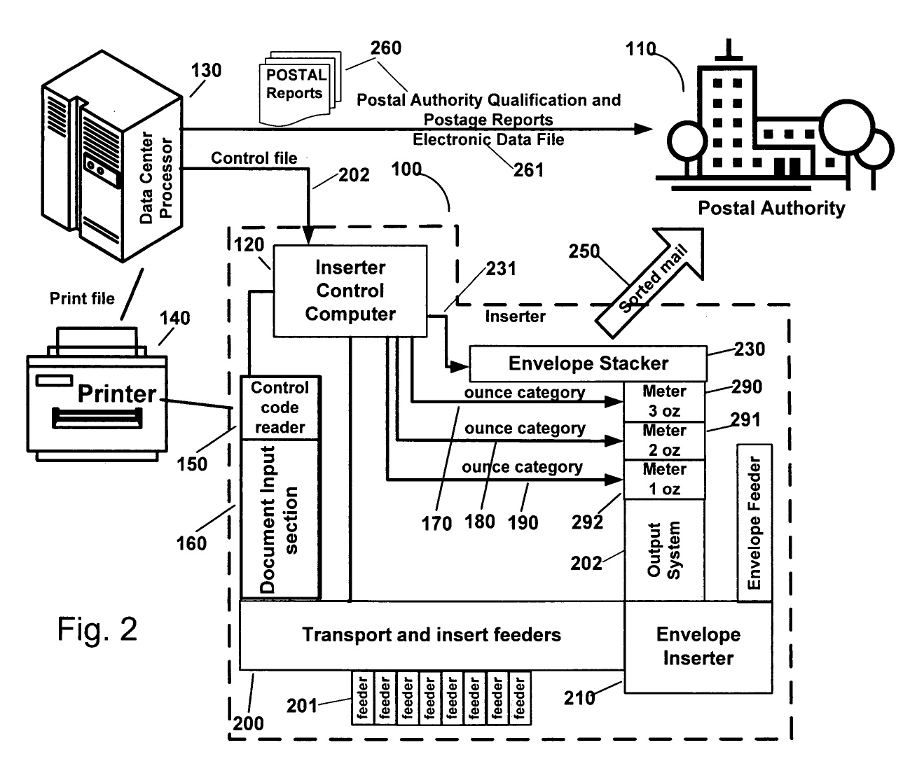

An Automated Document Factory (ADF) may contain a large variety of equipment necessary to finish mail for delivery to a postal authority for delivery. FIG. 2 shows some of the features contained in a typical ADF. The ADF can include document processors, address list processors and data center processors 130, printers 140, multiple document inserters 100 and sorting equipment. The ADF interfaces with the postal authority 11 by providing sorted mail 250 and the accompanying hardcopy 260 or electronic reports 261 necessary to document the “work share” performed to qualify for discounts and documentation to account for the postage due for the mailing. The format for electronic data 261 and 291 can be whatever the postal authority requires. Generally all data that is reported in hardcopy reports 260 and 290 is included plus additional detail on individual mailpieces for quality, audit and tracking is added. The current standard for USPS is mail.dat. The basic inserter system 100 comes in numerous configurations to meet specialized document processing requirements. Shown in FIG. 1 is one possible representation. Documents to be inserted are created on a printer 140 in roll, fan fold, or sheet format and loaded on the inserter document input section 16 for processing. The document input section may contain cutters, accumulators and folders as required. A control code reader 150 is generally included to read control data from barcodes or other indicia to identify the document characteristics such as page count, insert requirement, ZIPCODE, weight plus other parameters to control document production and transfer the data to the inserter control computer 120.

A ZIPCODE is the numeric or alpha numeric representation of the delivery point information. Delivery point information for the USPS is frequently referred to as the ZIPCODE which is represented in a barcode of various formats such as the USPS POSTNET, Address Block barcode and as a human readable number in the address block. Numerous other formats, either human readable or coded, for delivery point information are used by postal authorities. For the USPS the most complete ZIPCODE is 11 digits and represents the delivery point. Three digits of the ZIPCODE identify a processing center and five digits represent an associated delivery office. Finished mail is generally trayed in groupings of common three or five digits but other groupings are allowed. Alternately or in addition to the control codes, a control file 202, which contains all necessary control information, is sent to the inserter control computer. The document is input to the transport 200 where inserts will be added as required with the insert feeders 201. Finally the entire collated material needed to create the finished mailpiece is inserted into an envelope in the envelope inserter 210. The finished mailpiece is then sent to the output system where it is re-oriented as required for any subsequent processing.

If postage meters are the chosen method to applying postage, a meter will be added to the system. If all of the mailpieces being manufactured are within the same weight category, only a single meter is required, i.e., meter 292 for processing one ounce mail. The postage amount is preprogrammed into the meter by the operator and each piece will be imprinted with the same postage value. In the case where the mail created falls into multiple weight categories, however, multiple meters 290, 291, 292 are utilized. Each meter is programmed with a different postage value depending on the weight categories established by the postal authority. In FIG. 2, one, two and three ounce categories are programmed into the three meters so that the correct postage is affixed based on the mailpiece weight. For the multi-ounce metering system to work the inserter control computer 120 tracks the location of the mailpiece within the machine through each stage of processing. When the mailpiece leaves the output system, the inserter control computer 120 enables the correct meter for the weight category of the mailpiece about to enter the group of meters. Control signals 170, 180, 190 ensure the correct postage is applied.

The final step is to stack the mail for sweeping into postal mail trays. In order to ensure that the sweeping is done correctly, a tray break signal 231 is sent to the stacker 230. This signal enables the stacker to mark or offset in the stack the last piece to go in a given tray. Alternately the first mailpiece in the next tray could be marked. Accurate tray sweeping is critical to obtaining postal authority discounts since the tray contents must match the tray tag. The tray tag identifies the sort grouping, such as a common 3-digit or 5-digit ZIPCODE group. The sorting into groups is typically done in the data center processor 130 when the print file 141 is created. Additional processes for preparing mail such as address cleansing, move updating, determination of mail piece weight and presorting for rate-class discounts must be completed by the data center processor 130 or by processes that are executed before data is transferred to the data center processor. Sorting the documents according to postal authority rules before the print file is created results in the documents being manufactured in accordance with sortation rules. Alternately, the mail can be manufactured in any order and put into the correct groupings using a sorting machine. Typically, sorted mail 250 in correctly tagged trays is provided as a mailing to the postal authority. Numerous inserters 100 may have been used to create the mailing. Accompanying the physical mail are hardcopy reports 260 which define the “work share” qualification data and postage due. The postage due may not be the same as the summation of all the postage affixed by the meters to the mail pieces since different postage amounts may be required on individual groups of mailpieces due to the qualification data reported. The mailer may have to pay additional postage or receive a refund when the mail is presented to the postal authority mail acceptance unit.

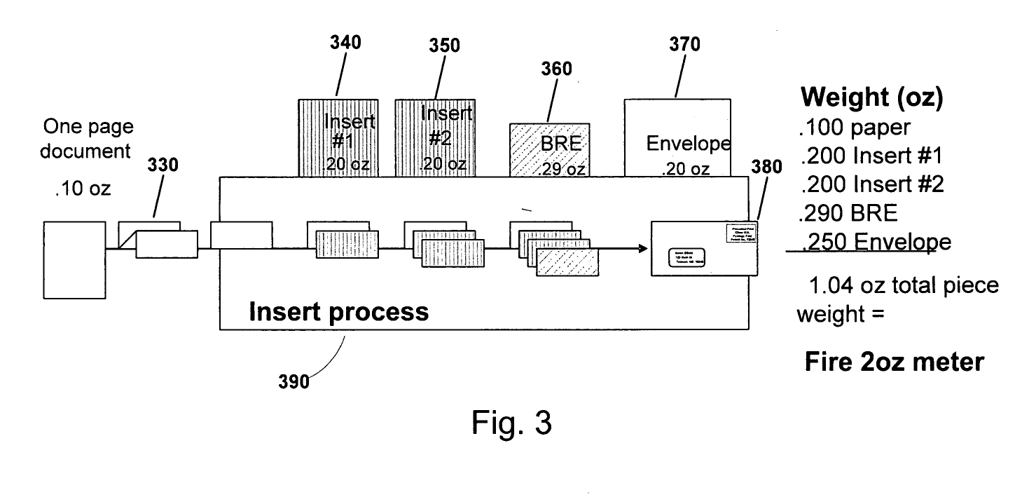

FIG. 3 is a diagram of computerized process for weighing of mailpieces. During the inserting process 390, the inserter control computer 120 is used to accurately determine the weight of a finished mailpiece. When new materials such as paper 330, envelopes 370 and inserts 340, 350, 360 are received, they are weighed to a fraction of an ounce. Then during setup, the weight of each mail piece element is entered into the inserter control computer by the inserter operator or transferred from the data center processor 130. Mail is assembled as usual; as mail is finished, the computer electronically calculates the total piece weight of the finished envelope 380 by combining the known weights of the envelope and its contents. This information lets the inserter control computer to know which meter (i.e., 1-, 2- or 3-ounces) to activate.

Attention should now be directed to FIG. 1, which depicts an ADF configuration where postage meters are replaced with a verification system 220. The verification system is placed in the location where a postage meter would normally be located. The interface(s) of the system 220 to the other elements of the document processing system, in this example, of the inserter system 100, is the same as would otherwise have been used for inclusion of a postage meter. As will be discussed, the various weight categories and corresponding interfaces may be conveyed via a variable weight interface 195 (e.g., digital I/O channel).

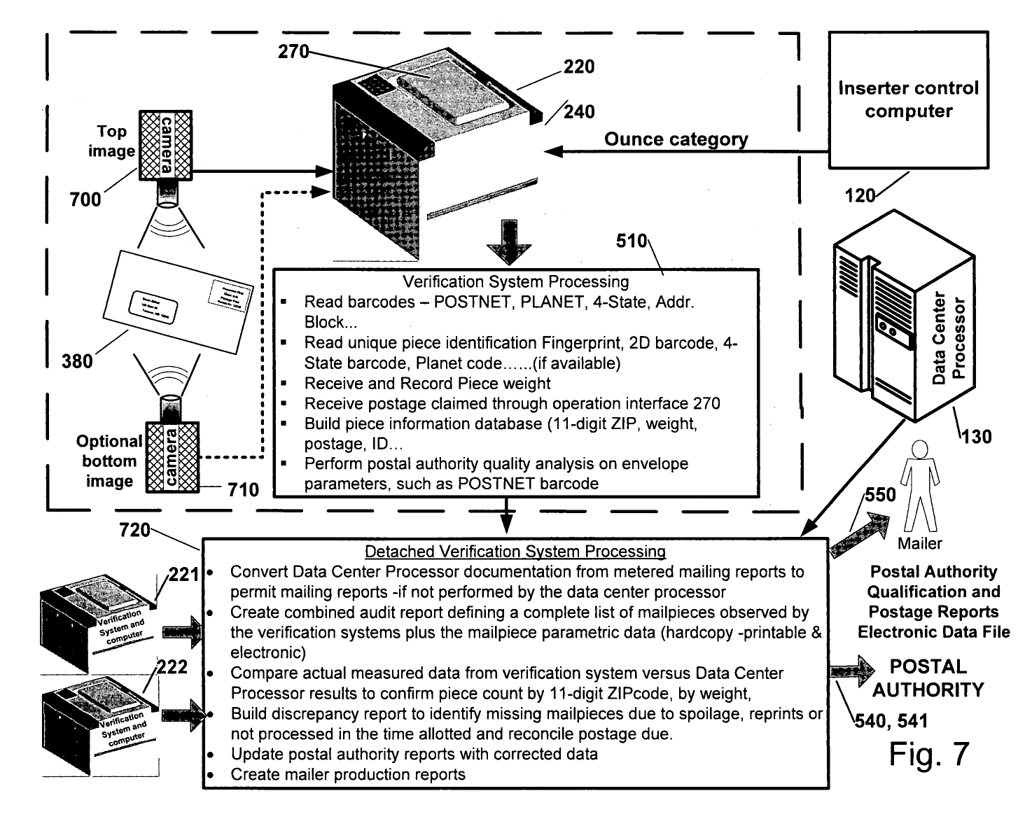

The verification system may be designed to receive data from the inserter control computer 120 and to collect an image of each mail piece. The verification system is combined with a verification computer 240 to interface with the data center processor 130, process image data received from the system camera system 700 and/or 710 (discussed in more detail with respect to FIG. 7) and to process data from the inserter control computer 120 which is routed through the system. Depending on available space and system configuration the verification computer 240 can be located in the system or kept as a separate unit. Similarly, the verification system may also be coupled to or include an operator work station 270 for allowing a user to access the various functions and control mechanisms of the verification system. The work station 270 can be integrated into the system or act as a stand alone unit. For the sake of clarity, when referring to the verification system 220 in subsequent sections of the description, it is assumed that the verification system 220 is always connected to the verification computer 240 and an operator work station 270. Similarly, the verification system 220 may be assumed to have imaging capability, either as an internal capability of the device or via the use of peripheral camera or imaging devices 700 and 710 of FIG. 7. Therefore the individual components will not always be individually identified when referring to the verification system. Unless subcomponents of the verification system are specifically discussed the term verification system 220 should be considered to contain the verification computer 240, the operator interface 270, and a means of imaging capability.

The verification system shown in FIG. 1 depicts its utilization within a mixed-weight mailing environment. The verification system 220 collects data on every mailpiece processed by the single or group of inserters that are required to manufacture a mailing. Each mailpiece is tracked in the inserter and weight of the finished envelope is known based on computerized weighing. However, the verification system emulates existing meter technology by connecting into the inserting equipment both physically and electronically. The verification system user interface 270 looks and behaves like a meter's user interface, but since the verification system can be used to process mixed weight mail, one unit will replace multiple meters 290, 291, 292. Weight and corresponding postage amount is transferred to the verification system using the identical interface 170, 180, 190 that was required for the meter. Newer digital meters have a multi-ounce and piece-to-piece variable postage amount capability which can combine the individual mechanical meter control signals into an integrated interface 195. In this way, weight category information pertaining to each mail piece may be relayed to the verification system via a single interface 195 as opposed to a separate control signal per weight category 170, 180, 190 as in the typical ADF of FIG. 2.

The process flow for utilization of the verification system is as follows. Envelopes with pre-printed permit indicia using customer's mailing permit, authorized by the postal authority 110, are placed in the empty envelope feeder 203. Document statements from the printer 140 are loaded on to the document input section 160. If available, control file data 202 is down loaded from the data center processor 130. The control data continues all the information needed for the inserter control computer 120 to control the assembly of documents such as, but not limited to, page count, ZIPCODE, inserts required, piece weight and tray group. The operator will enter (program) the postage amount to be associated with each weight category into the verification system through the input terminal 270.

When the production run is started a document is input to the document input section and a control code is read by the reader 150 to either identify the document to match it with the control file or to decode the data to obtain the data necessary to build the finished envelope. The decode data can contain, but is not limited to, page count, ZIPCODE and tray group. From the time the control code is read until the finished document is placed in the stacker 230, its position in the inserter is tracked. When the document reaches the optional printer 280, the inserter control computer 120 will send a control signal 204 to the printer to print a date on the envelope in a manner approved by the postal authority. Currently approved formats place the date and originating ZIPCODE in a circle in the area immediately to the left of the pre-printed permit indicia. Other applications for the optional printer 280 may include, but are not limited to, full printing of permit indicia to a document (as opposed to pre-printed permit indicia), printing of permit indicia having incorporated therein barcode or tracking information, printing of photostamps for allowing the incorporation of user defined images, etc. Those skilled in the art will recognize that any form of acceptable postage markings in accord with postal authority regulations, may be employed with respect to the present teachings.

Some customers may require printing of other customized items such as simulated cancellation marks or even a unique sequence number per document/envelope for providing a means of identification and/or cataloging of document data. The sequence number may alternatively be displayed in association with the KEY line data for enhanced processing. In addition, weight category identification can be printed on the envelope. The location and format of the printed weight data is determined by the postal authority. Currently approved formats include P1, P2 and P3 corresponding to permit 1 ounce, permit 2 ounce and permit 3 ounce weight categories respectively. Optionally, the weight category information may be expressed to within a certain decimal range of accuracy as needed or required by the postal authority 110 (e.g., within 1/30^{th} of an ounce). Other formats, as is quite obvious to those having skill in the art, will evolve in the future. The printing technology to be employed may be a rotary slug, bubble jet or ink jet. Other high speed, non impact printing technology maybe used in the future without affecting the scope of the present teachings.

When the envelope reaches the verification system 220 an image is captured of the envelope, such as by a camera, multi-line scanner, optical character reader, or other imaging device. The area of the image may include the entire front of the envelope or selected areas such as the barcode containing the ZIPCODE data. The image capture device may be oriented either above or below the mailpiece depending on the orientation of the address data, i.e. facing up or down. Furthermore, the image capture device may be directly or indirectly interfaced with the verification system 220 for the capturing of images to account for differing application requirements. So, for example, the image capture device may be interfaced with another processor but operatively connected to the verification system 220 for enabling it to acquire and/or process said image data via a shared communication channel. The processor or computer associated with the verification system 220 can be located in proximity to the verification system 200, located in an on site computer facility or remotely hosted at a offsite location. The network connectivity ensures that the operation of the verification system is not impacted by any of these configurations. In such instances, the image data may be processed by the other processor, but communicated to the verification system 220 via remote or network communication means. Regardless of the setup, any means of generating image data related to the envelope during processing for use and/or operation upon by the verification system 220 is within the scope of the teachings. Those skilled in the art will recognize that various imaging schemes, data communication schemes and configurations are well known and preferable to accommodate varying types of document processing system configurations and/or mail processing facility orientations.

At this point—upon acquiring image data for the envelope—a data file for this envelope is created by the verification system. At a minimum the file entry for an individual mailpiece will contain the complete delivery point identification, in the case of the United States postal Service USPS an 11-digit ZIPCODE, plus the weight category and postage claimed for this category. The ZIPCODE may be obtained by decoding a barcode from the image, while the weight category may be received from the inserter control computer 120 and the postage claimed is based on the operator entered data. Alternately, weight data can be read from the image if it is printed on the envelope or on the insert showing through the envelope window. Some current applications print the weight data in the KEY line. An inline scale also could be added as part of the verification system 220 or before the verification system (e.g., upstream within the inserter) as another proceeding module. Regardless of the chosen method of receipt, the weight category information may be conveyed approximately in concurrence with the capturing of image data for the envelope.

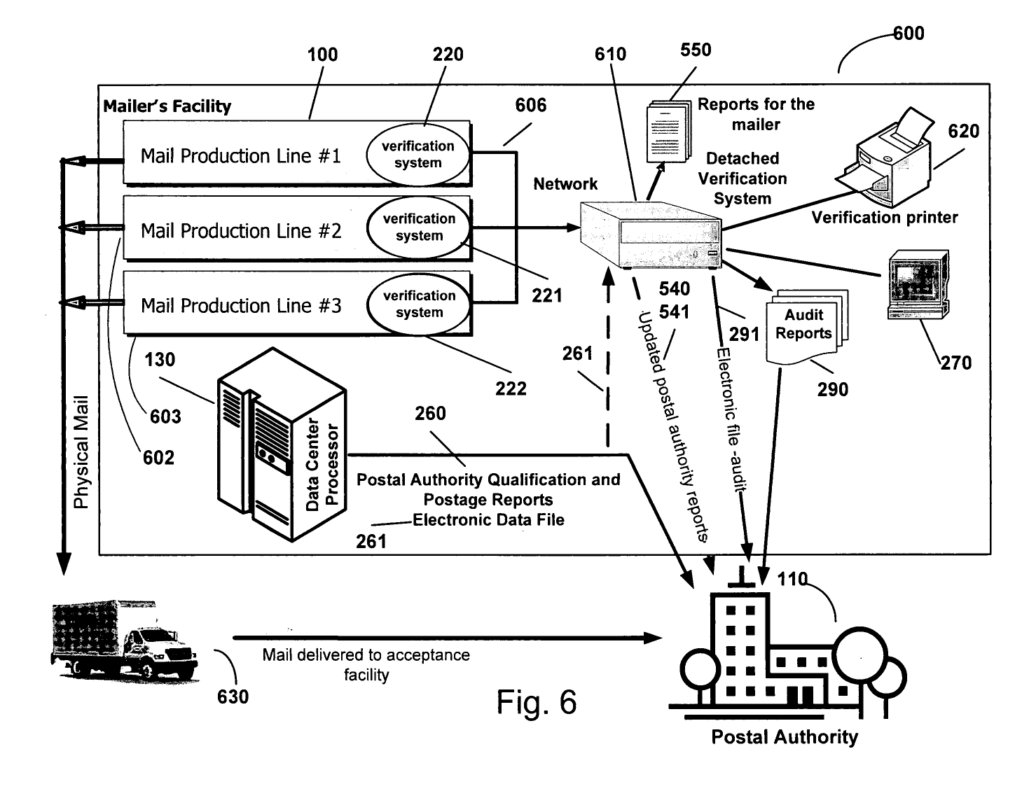

Additional data may be collected from the image and processed by the verification computer 240. The additional data can be used to create production quality reports 550, as will be discussed in more detail with respect to FIG. 6, which provides additional mail piece tracking data for the mailer and/or postal authority. Barcode reading technology and Optical Character Reading may be used to read PLANET code, IBIP, 4-State codes, addressee, return address, permit date, origination 5 digit ZIPCODE and weight. Other parameters can be decoded and read from the image as future mail processing requirements evolve. The format for inclusion of this data into postal authority and mailer reports will be defined by the respective groups.

The verification system tracks the number of mail pieces by weight, postage claimed and 11-digit ZIP code. Alternatively, the verification system may track the above mentioned parameters in association with the designated sequence number of each respective mail piece. This data is securely stored and used to build a postal audit report 290 and an accompanying electronic version 291. Mail is then delivered to postal authority, accompanied by standard documentation and the additional Verification Appliance audits. Postage is paid at the time of submission via the reports generated when the print stream is produced, and the funds are deducted from the account that is associated with the mailing permit.

As discussed previously, various data must be reported to the postal authority at some point with respect to a mail processing run by the inserter 100. The standard documentation that must accompany a mailing when delivered to the postal authority is created by the data center processor 130. The reports must be in the format acceptable for permit mailings. Generally this includes a qualification report that shows the makeup of the mailing based on the pre-sorting that was performed and a postage summary report which identifies the postage due. Greater accuracy in the postal authority reports can be obtained if the data center reports 260, 261 are routed to the verification computer 240. Assuming the standard reports from the data center processor would adhere to meter format standards, the verification system would convert these reports to conform to permit standards. Alternately, the verification system can use the actual mail piece data collected by the system to update the postal authority reports for any spoilage that occurs during mail production.

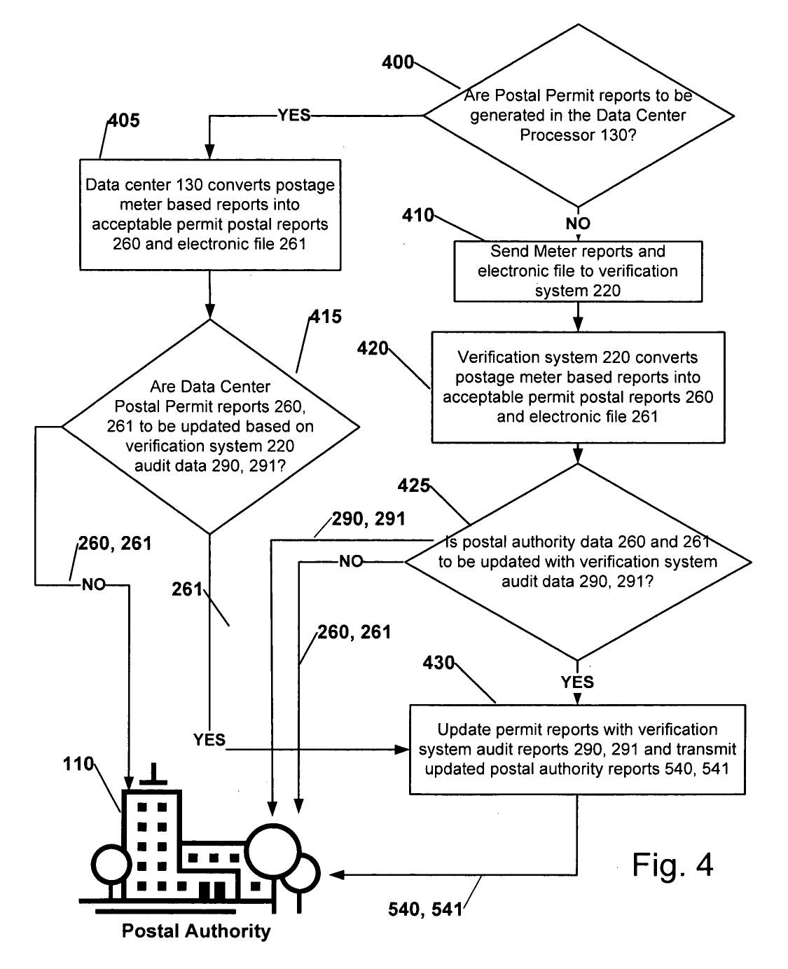

The addition of a verification system into what was a postage meter environment results in several options for postal authority hardcopy 260 and electronic data 261 reports. FIG. 4 demonstrates examples of the various possibilities that may be employed by those skilled in the art or upon postal authority direction, for generating various useful postal or mailer reports. The data center processor 130 has all the data needed to create the postal authority data whether some of the functions were performed by preceding processes such as address list processing, move update, National Change Of Address (NCOA) processing, delivery point validation (DPV), pre-sort analysis and print stream optimization. Since the ADF may be a postage meter site that is adapting to use the verification system, the normal postal authority reports will be those associated with metered mailings. Normally the data center processor would make the change to permit documentation 400, 405. An alternate mailing system may be used by the postal authority to define the acceptable permit report formats 260, 261. If the changes can not be made in the data center processor then the existing metered mailing data will be sent to the verification system 410. The verification system would then make the report conversion 420.

Another alternative exists to update the reports that originated from the data center processor with the audit data from the verification system. If no updates are to be made then the permit reports 260, 261 from the verification system 425 or from the data center processor 415 will be sent to the postal authority by the respective system 220 or 130. These reports will either accompany the physical mail or be sent in advance to provide improved planning for the postal authority. In either case the audit reports, both hardcopy 290 and electronic 291 will be sent to the postal authority since they contain the individual mailpiece data that the postal authority can use for audit of the mail received and the postage paid. In the case where the postal reports will be updated with the audit data from the verification system, the processing block 430 will process the postal authority reports supplied by either process 415 or 425. By comparing the input reports with the audit data, corrections can be made for any pieces that are missing from the mailpieces observed by the verification system and the mailpieces that the data center processor expected would be processed for the mailing. Discrepancies result from damage and spoilage due to jams, miss feeds, cutter errors, envelope inserter or other inserter processes. Another discrepancy can occur if the entire mailing has not been inserted before the dispatch deadline for the postal authority occurs. In this case the production manager may decide to dispatch the completed mail and hold the rest of the mail for dispatch the next day. The verification system 220 makes providing the correct postal authority reports easier since the process is automated, thus avoiding a manual update to the reports. Initially the updated hardcopy reports 540 and the updated electronic data 541 will be provided along with the audit reports 290 and 291. This gives the postal authority 220 highly accurate data and the detailed data needed for audit. In the future both reports may be combined into a single complete report. Table 1 summarizes the report generation options that can be created in the data center processor 130, verification system or detached verification system (DVA) 610 FIG. 6.

TABLE 1
Report Generation Options

| | | Reference |
|---|---|---|
| Postal Authority Reports | Generation Source Options | figures |
| Hard copy or printable file -260 | Generated by data center processor 130 and | |
| Electronic file - 261 | converted from meter to permit formats | |
| | Alternately the format conversion may be | |
| | done by the verification system 220 or DVA | |
| | 610 | |
| Hard copy or printable file -290 | Generated by verification system 220 or DVA. | |
| Efectronic file - 291 | Audit reports containing individual mailpiece | |
| | data. | |
| Hard copy or printable file -540 | Generated by the verification system 220 or | |
| Electronic file - 541 | DVA. The reports are updated with the audit | |
| | data so that the standard postal authority reports | |
| | are corrected for differences between planned | |
| | and actual production. | |
| Hard copy or printable file -940 | Generated by the verification system 220 or | |
| Electronic file -941 | DVA. postal authority reports representing | |
| | actual production results without interface to | |
| | data center processor 130. | |

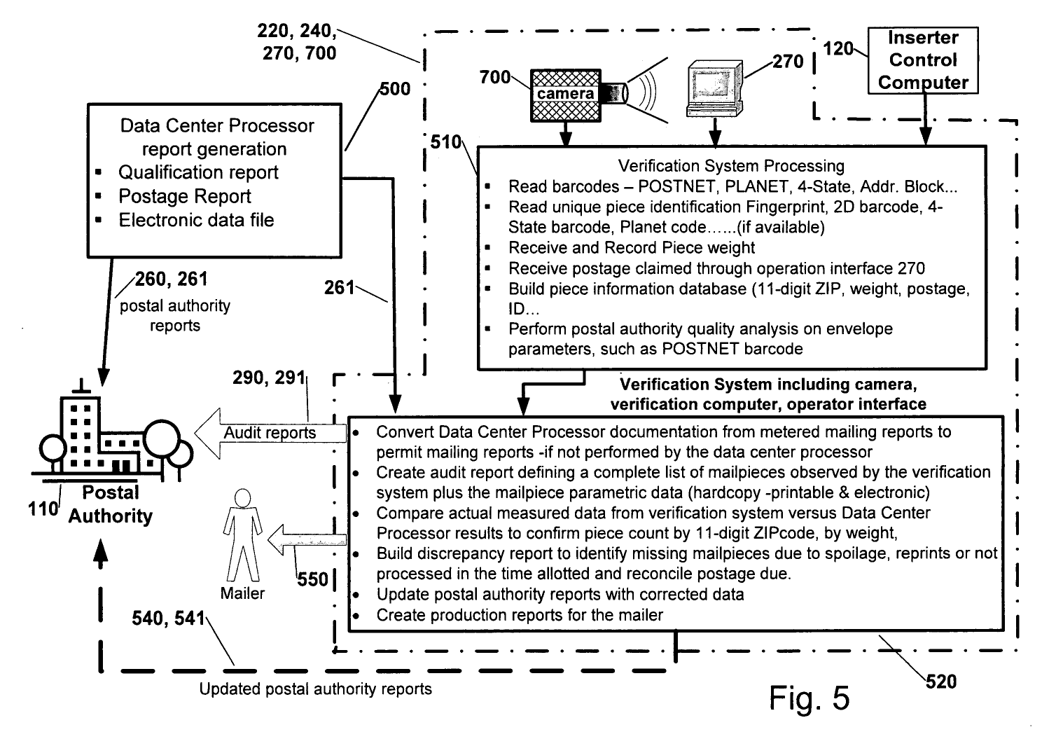

The description now proceeds with reference to FIG. 5, which depicts a flowchart of the processing functions performed by the verification system 220. As described previously, the verification system 220 includes a verification computer 240 and an imaging device 700 for capturing images of mail pieces as they are processed through the inserter 100. Also, coupled to the verification system may be a workstation 270 and inserter control computer 120. As a first phase of processing depicted in 510, the imaging device 700 is used to read barcodes that may show up on the mail piece such as POSTNET or PLANET codes, 4-State barcode, and address block barcode, or barcodes embedded within indicia markings (e.g., IBI Lite). Also, the verification system 220 may process any unique mail piece identification markings such as mail piece fingerprint data, sequence number, processing device serial identification data, 2D barcode, 4-State barcode identification, etc. (if available). Interpretation of such data may be performed using optical character recognition technology (OCR). Typical OCR utilities include the optical scanner for reading text, barcode readers (BCR) for interpreting delivery point barcode data (e.g., deciphering the barcode into an 11-digit zipcode), and sophisticated software for analyzing images. Alternatively, the OCR system may include a combination of hardware (e.g., specialized circuit boards) and software to recognize characters, or can be executed entirely through software operating within the verification system 220. As yet another alternative, in instances wherein the imaging device 700 is not interfaced directly with the verification system 220, the image processing functions may be performed externally (e.g., by an independent processor), and subsequently communicated to the verification system 220 over a network. Those skilled in the art will recognize that various OCR utilities and configurations may be employed by the verification system 220 for the purpose of recognizing a plurality of markings that may appear on a mail piece.

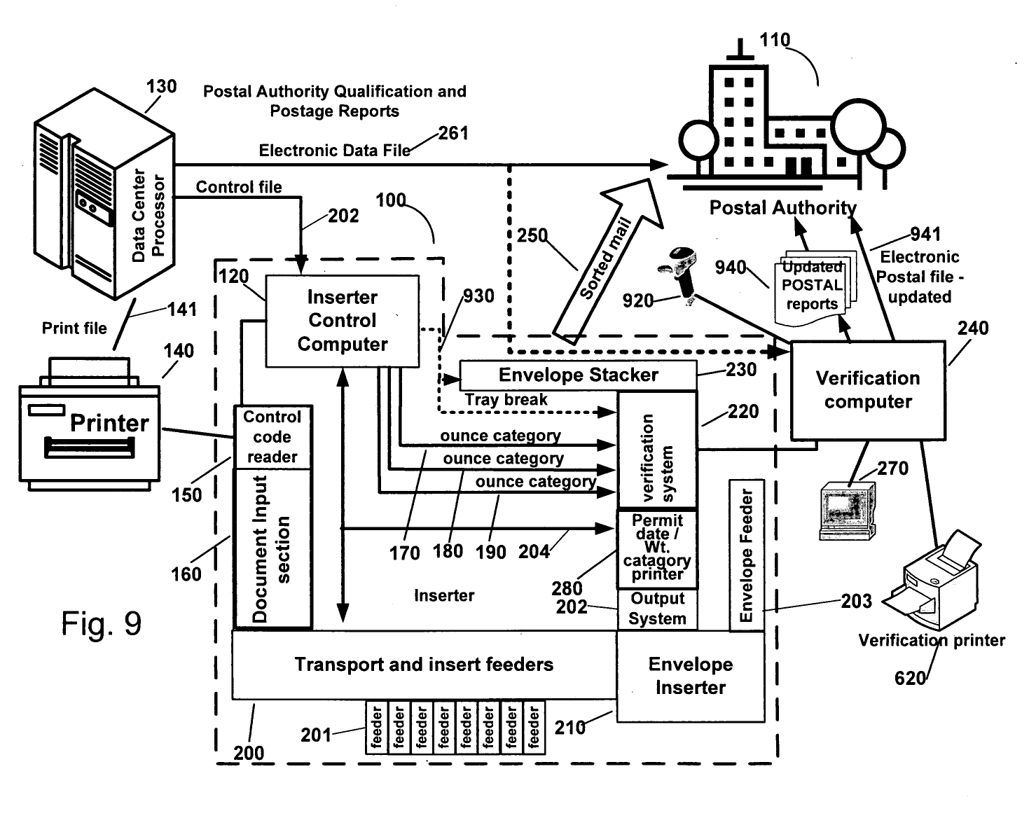

Other processing functions 510 performed by the verification system 220 include the recording of piece weight data as indicated by the inserter control computer 120 through meter interface lines 170, 180 and 190. Variable weight data is likewise recorded and maintained in the instance an integrated interface line 195 is utilized. Further weight data that may be reported include single piece weight for recording weight data for mail pieces of a common weight category, and full rate for recording full rate permit data by ounce category. Tray break data 930 FIG. 9 also may be provided from the inserter control computer. Once all data is collected, it can be compiled into a mail piece information database containing data pertaining to each mail piece. Stored data elements may include one or more of an 11-digit zip code, piece weight data, postage data, identification information and the like of each mail piece processed by the inserter 100. The various data elements stored within the mail piece information database may be optionally presented to the user on the workstation 270 via a graphical user interface (GUI) in real-time as each mail piece is processed. The workstation 270 also is used to enter the postage amount to be claimed versus weight category before the start of the production run. The interface may be designed to as a GUI to match the display characteristics for a given postage meter type. (Alternatively, those skilled in the art will recognize that the user interface may be rendered by any other computer associated with the document processing system 100, such as the inserter control computer 120). Furthermore, the verification system 220 may perform standard postal authority quality analysis on envelop parameters, such as POSTNET barcode analysis. POSTNET barcode analysis data, such as barcode height, width, pitch, tilt and offset, may be generated for inclusion into a report generated by the verification system 220.

Additional processing functions capable of being performed by the verification system 220 are depicted in event block 520. As described previously with respect to FIG. 4, various report generation scenarios may be employed to ensure accurate mail piece and mail run processing data is generated. The data center processor 130 generally produces the postal authority qualification report and postage report 260, and electronic data file 261. However, in the event such data is to be submitted by the verification system 220 (event 400, FIG. 4), the verification system 220 converts the data center processor documentation from metered mailing reports to permit mailing reports (e.g., if not already done so by the data center processor 130). The verification system 220 also creates audit reports that define a complete list of mail pieces observed by the verification system plus mail piece parametric data (provides at least one of a hardcopy-printable 290 and electronic version 290). This corresponds to event 425 of FIG. 4.

Such report metrics may be further used to compare actual measured data from the verification system 220 versus data center processor 130 results to confirm piece count by 11-digit ZIP code, by weight, etc. Also, a discrepancy report may be generated to indicate mail pieces that may have come up missing during runtime of the inserter 100 due to spoilage, reprints or improper time allotment. Such data would allow the postal authority or mailer to effectively reconcile postage due. So, for example, a mailer could more easily rectify overpayment on their part in cases where mail pieces paid via the permit agreement were not actually produced during runtime or had to be reprinted for quality purposes due to errors. In this example, the mailer would have viable proof using data obtained during actual runtime processing to show which specific mail pieces did and did not get properly processed.

As an additional processing feature illustrated in event block 520, the above described report metrics and data may be combined with the information provided in a traditional postal authority report, resulting in an updated postal authority report that features corrected data (e.g., actual runtime data). This updated postal authority report may then be sent to the postal authority 110 in at least one of hardcopy 540 and electronic forms 541 (event 430, FIG. 4). Additionally, a mailer report 550 can be created in a format suitable to the inserter operator or production manager, which may include much of the data provided in the postal qualification reports and audit report, or other more application specific data.

Turning now to FIG. 6, an example network environment for the usage of multiple verification systems to enable mail processing on multiple inserting machines is depicted. In particular, a mailer's facility 600 includes several mail production lines 100, 602 and 603 which are each configured with a verification system 220, 221 and 223 respectively to provide the same features described previously. All of the verification systems are capable of communicating over a network and are configured to a network 606. The network 606 may be any configuration of internal or private network arrangement specific to the mailer's facility 600 such as an intranet or peer-to-peer network, or may be arranged to enable remote communication such as via the internet. All images, verification data, reports and other information generated by each Verification system 220, 221 and 223 during runtime of the mail production lines 100, 602 and 603 is sent over the network to a detached verification system 610. Information collected by the verification system for transmission over the network 606 may include, but is not limited to zip code information, piece weight data, piece count data, etc.

The detached verification system 610 is an independent, network capable device such as a server that acts as an aggregator of the various production run data generated by each mail production line and corresponding verification system. Coupled to the detached verification system 610 is a workstation 270 and keyboard for a providing a user interface to influence the behavior of the detached verification system 610. The workstation 270 performs the same functions as described previously with respect to FIG. 1. Mail data may be compiled by the detached verification system 610 concurrently with the transmission of data by a respective verification system 220, 221, 222, resulting in an approximate or intermittent real-time data collection. Alternatively, the data generated during the runtime of a particular mail processing line 100, 602 and 603 by a respective verification system 220, 221 and 222 may be transmitted upon the completion of a run and then submitted to the detached verification system 610.

Upon receiving the data, the detached verification system 410 aggregates the data into the various reports described with respect to FIG. 4, including: a properly formatted qualification and postage report 260 and 261 (hardcopy and/or electronic)—assuming this was not generated and submitted by the data processor 130; and audit report 290 and 291 (hardcopy and/or electronic); an updated postal authority report 540 and 541 (hardcopy and/or electronic); and a mailer report 550 which can be used by the operator of the mailer facility 600 to view data relating the results of each individual mail production line 100, 602 and 603, or the combined mail run. Data within the mailer report 620 may be similar to that provided in the qualification report generated for the postal authority 110, or can include additional data more specific to the needs of the mail run operator, i.e. data indicating any spoilage that occurred during mail production. The detached verification system 610 may also generate reports metrics for comparing actual mail qualification data obtained by the detached verification system 610 with expected mail qualification data obtained from the data processor 130. In this way, mail piece counts by 11-digit ZIPCODE, by weight, etc. can be checked to ensure mail processing integrity and postage reconciliation purposes. A verification printer 620 can be attached to the detached verification system 610 or to any verification system 220 to print reports or updated tray tags.

Suffice to say, a distributed verification system environment 600 as described is particularly useful in instances where more than one mail production line (e.g., more than one inserter to complete a batch of mailings) must be utilized to produce a complete mailing for delivery 630. It will be appreciated by those skilled in the art that functionality of the detached verification system 610 is similar to that of the verification system, except without being necessarily attached to an inserter. Hence, the detached verification device 610 can be easily adapted for usage within a mailing facility 600 already having one or more existing verification devices operating in conjunction with one or more inserters without requiring extensive reconfiguration of the mail facility 600. Furthermore, it will be appreciated by those skilled in the art that the functions performed by the detached verification system 610 could instead be performed by one of the inline verification systems (either 220, 221 or 222), configured in a simple master/servant processing arrangement. In this case, the master verification system would be responsible for aggregating the data, reports and other metrics generated by itself and the other two servant verification systems accordingly.

Turning now to FIG. 7, an example flowchart depicting the processing functions of the detached verification system 610 as used in connection with other verification systems, as discussed in FIG. 6 is shown. Close observation of the flowchart of FIG. 7 shows that processing in a distributed environment is identical in nature, but not necessarily entirely in function, to that of a non-distributed environment as described in FIG. 5. As discussed previously, the verification systems 220, 221 and 223 perform the same processing functions 510 (e.g., recording piece weight, POSTNET analysis/certification, etc.) However, the detached verification system 610 performs the other processing functions represented in FIG. 5 as event 520, including the generation of updated postal authority reports 540 and 541, and mailer report generation 550. As such, many of the processing tasks 720 performed by a single verification device in FIG. 5, are performed on behalf of the one or more verification devices 220, 221 and 222 by the detached verification system 610 in the distributed environment. Those skilled in the art will appreciate the reduced processing time required of the verification systems in such a configuration. Just as importantly, the practitioner will appreciate the ease of auditing capability presented to the postal authority 110 by such a configuration. Rather than having to audit or perform integrity verification for each of the individual verification systems 220-222—a frequently performed task when meters are used instead of verification systems—the detached verification system need only be inspected or audited (e.g., assuming the detached verification system is registered with the postal authority as a postal authority certified mailing device). Individual verification systems could be registered with the postal authority as a postal authority certified mailing device. This is a significant advantage, particularly when one considers that some mailing facilities may employ the usage of hundreds a various mail production lines, running millions of mail pieces a day.

It should be noted that the data center processor 130 may interface directly with each of the verification systems 220, 221 and 223 in addition to, or instead of the detached verification system 610. When linked directly to the verification systems 220-222 and not to the detached verification system 610, the conversion of meter mailing reports to permit mailing reports is performed by each verification system respectively, and then aggregated by the detached verification system 610 into a final conversion report suitable for submission to the postal authority 110. This may be suitable in situations where network bandwidth and resources are limited, resulting in more effective load balancing.

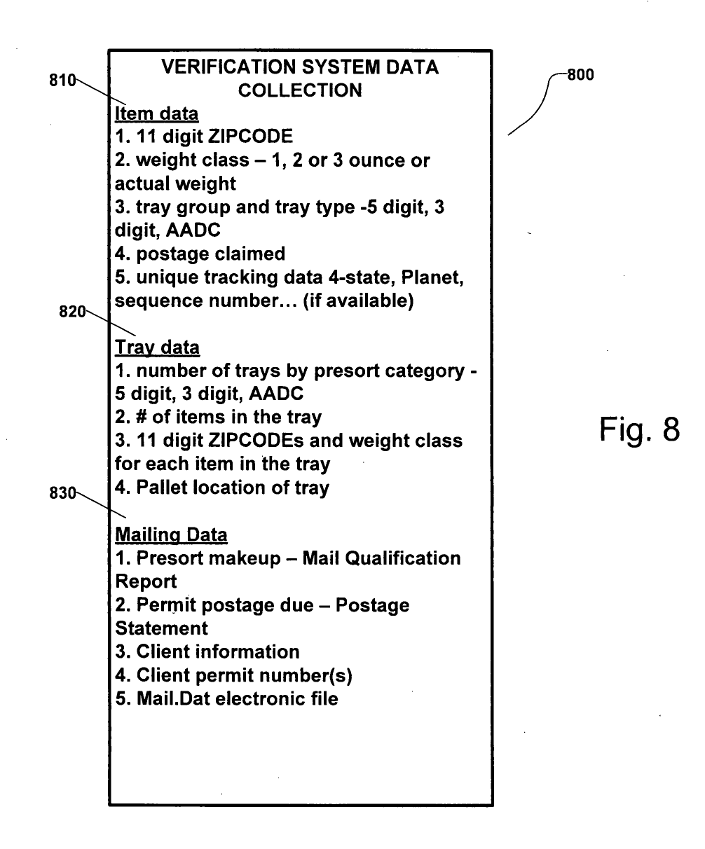

Numerous report formats for both the hardcopy reports and the electronic data will be established by the postal authorities. Critical to the ability to create any required report is the collection and storage of data 800, FIG. 8 by either the verification system 220 or the detached verification system 610. The data stored is divided into three major categories. Item data 810 contains all of the data associated with an individual mail piece. Since all of the mailpieces are delivered to the postal authority in mail trays or tubs, tray data 820 is collected. This data field defines the make up of the tray contents such as presort category, mailpiece count, ZIPCODE ranges for the mailpiece and unique tray identification if available. Additional data can be added as required (e.g., unique sequence number or machine serial number/identification value). Data that defines the entire mailing 830 which is needed to create qualification and postage reports, is saved in the same database. This data may be derived from the tray data 820 and item data 810, received from the inserter control computer 120 or data center processor 130 or input by the operator through the verification system interface 270.

Since one of the postal authority goals in supporting the utilization of a verification system is the accuracy of the data reported versus the actual mail manufactured, an appropriate means of presenting and delivering information is required. If the hardcopy and electronic reports are entirely generated based on the mailpieces actually observed, then the reports provided will not contain errors in the mail qualification data or postage data. In addition, with the individual mailpiece data that will accompany the standard reports, high levels of auditing can be achieved by the postal authority during mail acceptance. FIGS. 9 through 13 define the processes involved.

The verification system will operate without connection to the data center processor 130 FIG. 9. Additional quality and reporting is obtained by adding a tray tag scanner 920 and a verification printer 910. The tray tag scanner 920 is used to scan each tray tag after mail is swept into the tray to verify that the correct tag was added to the correct tray based on its known contents. The verification printer 620 is used to print corrected tray tags, postal authority reports, mailer reports and audit reports. Other reports may be added as required.

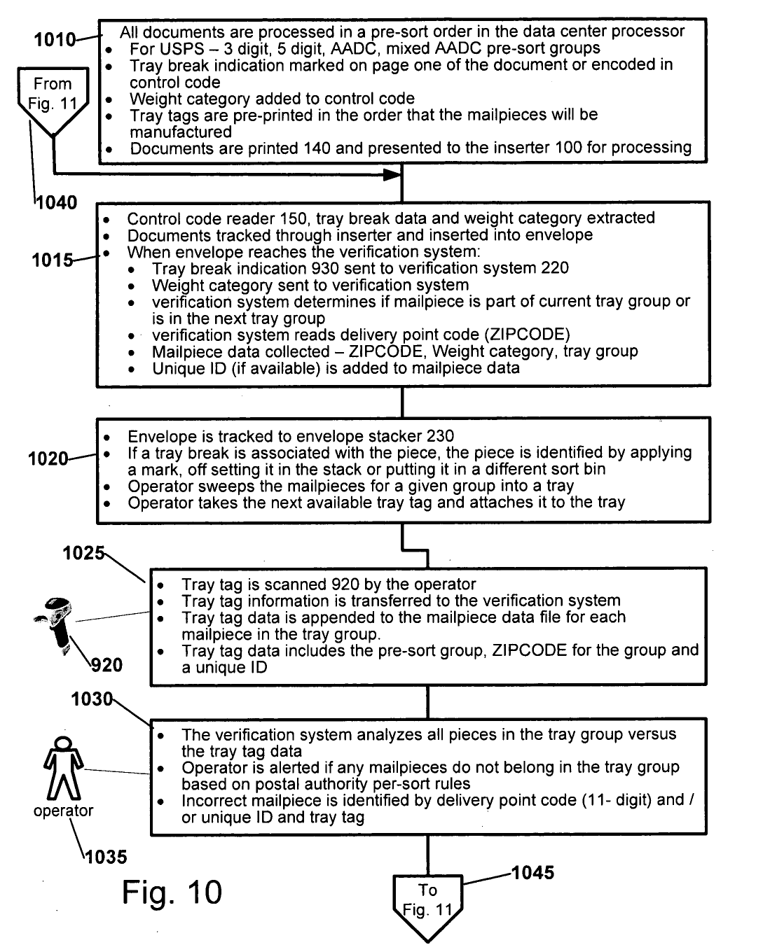

The report generation process starts with the control and collection steps shown in FIG. 10. In step 1010, document data files are processed in the data center processor prior to printing. All documents are processed in a pre-sort order in the data center processor. For USPS the presort groupings may include 3 digit, 5 digit, AADC, mixed AADC. Tray break indications are marked on page one of the document or encoded in control code plus the weight category is added to control code. Alternately this data can be sent to the inserter control computer 120 in a control file 202. Tray tags are pre-printed in the order that the mailpieces will be manufactured and swept into mail trays. Finally the documents are printed 140 and presented to the inserter 100 for processing.

In step 1015, the document is processed on the inserter the control code reader 150 reads the code and extracts tray break data and weight category. Documents are tracked through the inserter and inserted 210 into an envelope. When the envelope reaches the verification system 220, the tray break indication 930 is sent to verification system 220 and associated with the mailpiece data record. Tray break data is provided if the mailpiece is either the first or last piece in a given tray (depending on the inserter control configuration). Tray breaks occur when the presort group changes or the tray is calculated to be full. Weight category data 170, 180, 190 is sent to verification system and associated with the mailpiece being processed. If all mailpieces in the mailing are known to be in the same weight category, this step may be deleted. In this situation, the operator could enter the weight category through the interface 270. Using the tray break data, the verification system determines if mailpiece is part of current tray group or is in the next tray group. Next the verification system reads delivery point code (ZIPCODE). Mailpiece data is collected by the verification system and added to the database. The mailpiece data can include the ZIPCODE, weight category and tray group. Other parameters may be included such as a unique ID (if available) as read from a USPS 4-state barcode, indicia information or data extracted from the indicia, and postage due information.

Proceeding to step 1020, Envelope is tracked to envelope stacker 230. If a tray break is associated with the piece, the piece is identified by applying a mark, off setting it in the stack or putting it in a different sort bin. The operator sweeps the mailpieces for a given group into a tray and takes the next available tray tag and attaches it to the tray. In the next step 1025, the tray tag is scanned 920 by the operator and the data is transferred to the verification system. Tray tag data is appended to the mailpiece data file for each mailpiece in the tray group. Tray tag data includes the pre-sort group, ZIPCODE for the group. Other parameters such as unique tray ID may be encoded the tray tag barcode. The verification system analyzes all pieces in the tray group versus the tray tag data in step 1030. The operator is alerted if any mailpieces do not belong in the tray group based on postal authority per-sort rules. The incorrect mailpiece is identified by delivery point code (11-digit) and/or unique ID and tray tag for possible corrective action.

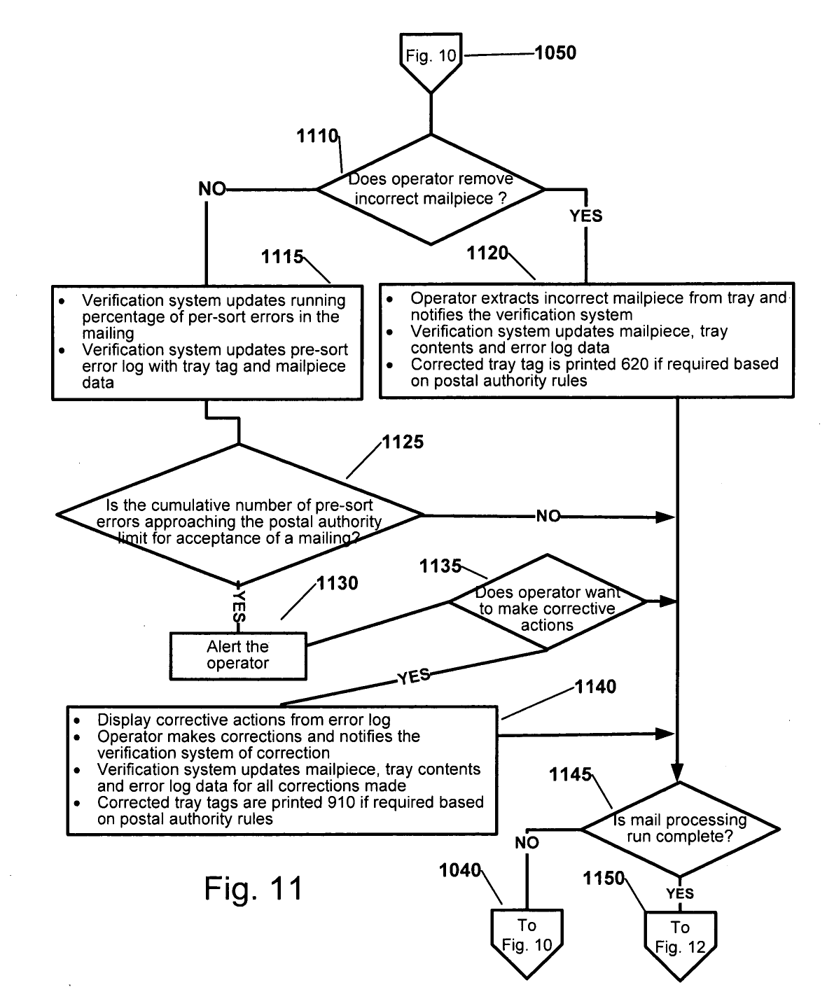

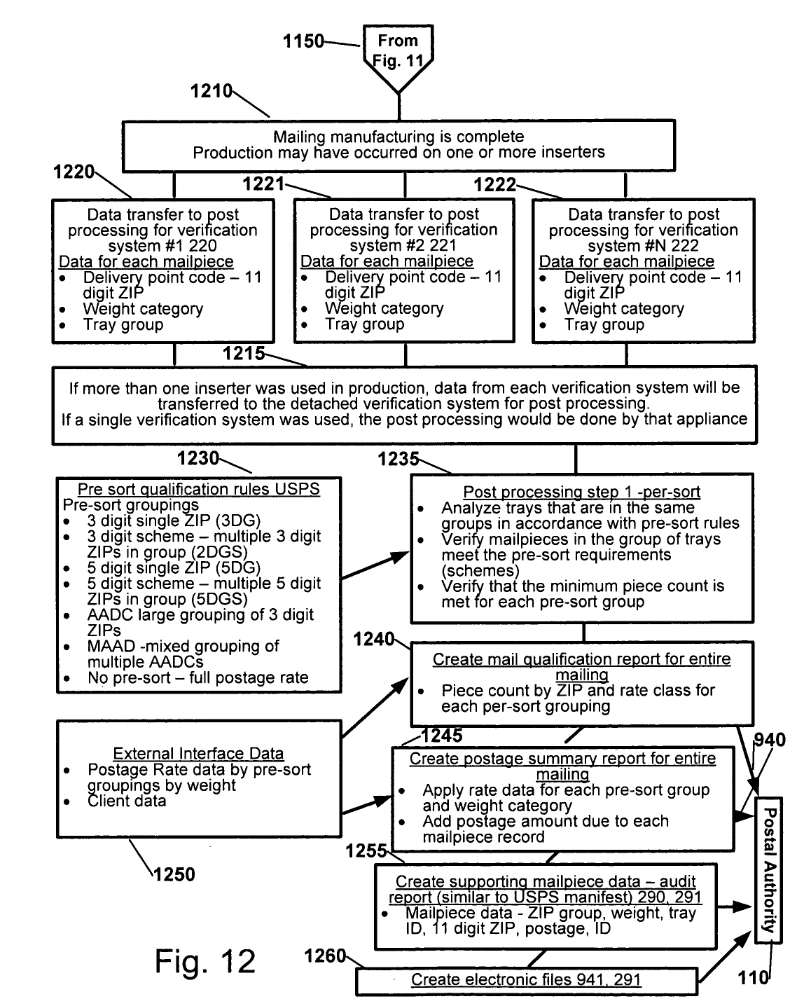

Since the postal authorities allow a certain percentage of the mailpieces to be in the incorrect tray, the operator may not take corrective action of every case. These errors can occur due to improperly handled reprints of damaged mailpieces or other processing errors. As a result the operator may not take corrective action 1110. The process which ensues under such circumstances is shown in FIG. 11. Specifically, for instances where corrective action is taken 1120 the operator extracts the incorrect mail piece(s) from the tray and notifies the verification system 220. The notification process can be engaged in various ways, such as through the usage of the verification computer 240 and a graphical user interface 270 for receiving operator command inputs. Upon receiving the notice, the verification system 220 updates the mail piece or tray contents, and updates any error log data manually. Alternatively, the verification system 220 may update the error log data electronically via a standard operator reconciliation process. Once this is done, corrected tray tags are printed 620 if required based on postal authority rules, and may then be applied as a final reconciliatory action. When more processing is required to complete the mail run, the exemplary operations described with respect to 1040 FIG. 10 are performed. If on the other hand the corrective actions taken by the operator complete the processing of the current mail run 1145, the next phase of processing is performed as described with respect to FIG. 12. The exemplary operations and procedures depicted in FIG. 12 will be described in later paragraphs of this description.

In instances where the operator does not remove incorrect mail pieces 1115, the verification system 220 maintains and updates a running percentage of pre-sort errors that occurred during the particular mail run. Thus, while the mail pieces are not necessarily corrected, statistical data may still be collected for future observation by the operator to improve future performance of the inserter. The verification system 220 then updates the pre-sort error log with tray tag and mail piece data (e.g., zip code, weight, postage due and/or other quality or postal authority data). If the cumulative number of pre-sort errors is approaching the postal authority limit for acceptance of a mailing 1125 (e.g., approaching to within an established variance), the operator is alerted 1130 such that corrective action may be taken 1135. Typically the operator will need to take corrective action, since exceeding the postal authority limit on presort errors may result in loss of discounts. The corrective actions that may be performed by the operator of the inserter 100 are illustrated by event 1140. Actions may include rendering the error log data to a display for review of the mail pieces requiring correction, correcting the error according to the error log and then notifying the verification system, updating mail piece, tray contents and error log data, etc. Once completed, mail processing commences as described previously with respect to event 1145.

Turning now to FIG. 12, the exemplary operation of one or more inserters 100 as employed in conjunction with one or more verification systems (e.g., verification systems 220-222) for post processing 1150 is illustrated. For multiple mail production line configurations 1210, data for each mail piece as collected during the mail run is transferred from each respective verification system 1215 to the detached verification system 610. This is illustrated in the figure as events 1220, 1221 and 1222 for verification systems 220, 221 and 222 respectively. Data to be transferred includes, but is not limited to, delivery point code data (e.g., 11 digit ZIPCODE), weight category information, postage claimed and tray group data. Alternatively, if a single verification system was employed during the mail run, the post processing is performed by that system.

The next step in the post processing phase is processing according to pre-sort qualification rules 1235. Trays that are in the same groups are analyzed in accordance with the rules, and then each mail piece is verified to ensure that each in the group of trays meet the pre-sort requirements (schemes). Also, verification is performed to ensure that the minimum piece count is met for each pre-sort group. Examples of the various pre-sort rules that a postal authority, such as USPS may employ are illustrated in box 1230. Pre-sort groupings may include the following: 3 digit single ZIP (3DG), 3 digit scheme—multiple 3 digit ZIPs in a group (3DGS), 5 digit single ZIP (5DG), 5 digit scheme—multiple 5 digit ZIPs in a group (5DGS), AADC large grouping of 3 digit ZIPs, MAAD-mixed grouping of multiple AADCs, and/or no pre-sort at all, which triggers a full postage rate to be applied to the mailing. Various postal authorities may establish various pre-sort qualification parameters. Usage of the various USPS pre-sort rules in the context of the present teachings described herein are provided for exemplary purposes only, and does not limit the scope or realm of applications of the novel concepts herein.

As a next step 1240, a mail qualification report is created that includes data pertaining to the entire mailing—mail piece data. As discussed previously, if mail piece data was collected and generated with a single verification device, then this device would generate the mail qualification report. However, when multiple verification devices are utilized, the device responsible for aggregating the collective information of each verification device—such as a detached verification system 610—performs this step. Information included within the qualification report may include, but is not limited to, piece count by ZIPCODE and/or rate class for each pre-sort grouping and weight category.

An postage summary report for the entire mailing—comprising all of the one or more mail pieces for the one or more mail production lines or inserters—is then generated step 1245. The qualification report from step 1240 is combined with the postage summary report to produce the postal authority reports 940 that is required by the postal authority 110 in verifying the integrity of the mailing and performing mail acceptance and collecting postage due. More importantly, the postage summary report provides data indicative of postage applications to mail pieces as they were captured during the runtime of the one or more inserters. Therefore, there are no errors in the report due to spoilage or missing mailpieces since the data was generated by what was actually observed by the verification system (s). If reprinted mailpieces are available before the mailing is complete, the operator has the option to add the mailpieces to the correct tray and update the verification system data through the graphical interface 270. In generating the postage summary report, step 1245, rate table data 1250 for each pre-sort group and weight category is accounted for. Using this data, the postage amount due to each mail piece record may then be added as needed. An obvious advantage to performing the processing step depicted in 1245 is the ability to improve the efficiency and effectiveness of the postage verification or audit process; as the report would include real-time or directly acquired data obtained during run-time as opposed to assumed postage application data obtained prior to runtime.

In an effort to further meet the requirements of the governing postal authority 110, supporting mail piece data and documentation may also be generated by the responsible verification system (e.g., a detached verification system when in a multi-processing mail run environment) 1255. Specifically, an audit report 290 may be created to be similar in function and or format to that of a manifest record as illustrated in FIG. 1. Data to be included in the audit report may include, but is not limited to ZIP code, group, weight category, tray ID, 11 digit ZIP, postage, mail piece ID, sequence number information, serial number, etc. Alternatively, the audit report may be prepared in an electronic form 291 for submission to the postal authority 110.

Those skilled in the art will recognize that some if not all of the pre and post mail processing steps presented in the exemplary embodiments, while illustrated as occurring in a sequential nature, may be performed concurrently when feasible. Furthermore, it is quite possible that the order in which certain processing events occur (e.g., events 1240 and 1245) may be interchanged, or optionally opted-out for completion by the operator. The order, mode and nature of the processing events as illustrated in the figures may be adapted as required to meet varying postal regulations and mail processing standards.

Once mail preparation is complete and all the necessary reports are generated, both the physical mail 630 and postal authority reports 260, 540 or 940 plus electronic files 261, 541 or 941 are provided to the postal authority in support of mail acceptance. The reports and files provided are based on the generation mode employed as explained in the proceeding discussion. Unique to the verification system, audit reports 290 and 291 are included since they contain individual mail piece data that postal authority regulations may require the combining of reports and additional formats in the future. Either the verification system or the detached verification system can reformat the extensive data collected for a specific mailing, FIG. 8 to meet postal authority regulations.

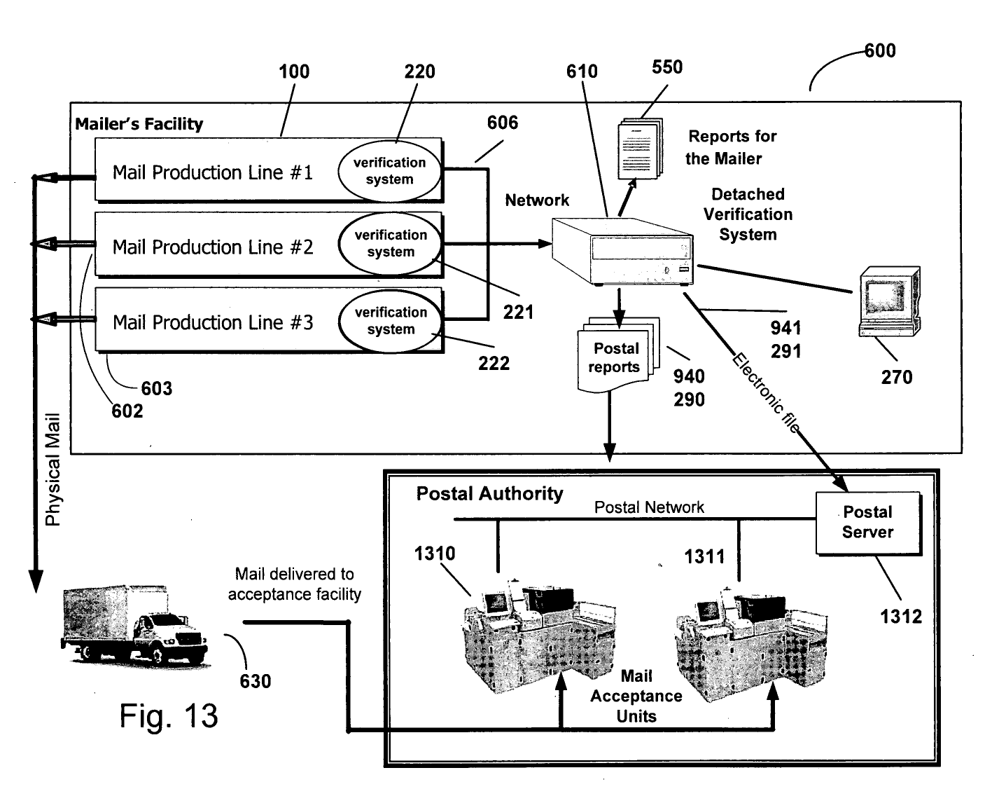

An exemplary mail acceptance process is depicted in FIG. 13. Electronic data is received by the postal server 1312 and saved awaiting mail acceptance by a postal clerk. Once the physical mail arrives at the postal authority it will be scheduled for acceptance on a mail acceptance unit 1310, 1311. Postal reports will accompany the mail and be used to identify the mailing. The hardcopy reports may be limited since an electronic version was provided by the verification system. In the USPS, the clerk would randomly select trays of mail to process on the acceptance unit, approximately 1000 mailpieces, and enter the mailing identification data into the acceptance unit. The acceptance unit would request the mailing data 941 and 291 from the server. The data transfer may be limited to the key parameters describing the mailing plus specific mail piece data for each tray to be tested. The tray identification data is read from the tray tag with a scanner on the acceptance unit 1310. If a unique tray ID is read then only the data for that tray needs to be transferred from the server 1312. If only the tray presort data is read, then all tray data for that group would be transferred. The specific tray is identified once the mailpieces are processed on the acceptance unit. Since the order of the delivery points (ZIPCODEs) in a given tray was recorded by the verification system and given that the order is unique for each tray, the tray and its contents will be uniquely identified. Once the mail has been process on the acceptance unit, the key parametric data can be validated against the verification system data since both units collect the much of the same data. If the data records match and the mailpieces meet postal standards such as barcode quality and physical measurements, the mailing will be accepted and postage collected.

Since the verification system has collected weight category data on each mailpiece and the acceptance unit weighs each mailpiece, an automatic verification that any additional postage due for mailpieces in weight categories above one ounce has been properly claimed can be validated. This is an important additional verification since a postage amount is not printed on the mailpiece. Manual weight audits can be done by the clerk if required since he can look up individual ZIPCODEs in the audit report 291 and verify the actual weight versus the weight category claimed. This is possible since there will be only a limited occurrences for more than one mailpiece with the identical delivery point in most business mailings. Since the audit data 291 and electronic files 941 are both in electronic format, a number of queries of the data can be programmed into the server 1312 or the acceptance unit 1310 to aid the clerk in the mail acceptance process.

As shown by the above discussion, many of the functions relating to the verification system are implemented on one or more computers, which of course may be connected for data communication via the components of a network. The hardware of such computer platforms typically is general purpose in nature, albeit with an appropriate network connection for communication with other system elements or equipment and/or for communication via the intranet the Internet and/or other data networks.

As known in the data processing and communications arts, each such general-purpose computer typically comprises a central processor, an internal communication bus, various types of memory (RA, ROM, EEPROM, cache memory, etc.), disk drives or other code and data storage systems, and one or more network interface cards or ports for communication purposes. The computer system also may be coupled to a display and one or more user input devices (not shown) such as alphanumeric and other keys of a keyboard, a mouse a trackball, etc., as represented generally by the workstation 270 in the example of FIG. 1. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or integrated into a verification system 220 as in FIG. 1 or even into sorting and/or inserting equipment.

The software functionalities involve programming, including executable code as well as associated stored data. The software code is executable by the general-purpose computer that functions as the particular computer, e.g. 240 (FIG. 1). In operation, the executable program code and the associated verification data are stored within the general-purpose computer platform. At other times, however the software may be stored at other locations and/or transported for loading into the appropriate general-purpose computer system. Hence, the embodiments involve one or more software products in the form of one or more modules of code carried by at least one machine-readable. Execution of such code by a processor of the computer platform enables the platform to implement the verification system functions, in essentially the manner performed in the embodiments discussed and illustrated herein.

As used herein, terms such as computer or machine “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s) operating as one of the computer 240 of the verification system as shown for example in FIG. 1. Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed is:

1. A system for verifying a mailing including a plurality of mail pieces, the verifying system comprising:
an image capturing device for acquiring image data associated with each mail piece processed by a document processing system;
a processor for processing the acquired image data of each mail piece,
one or more channels for receiving weight category for the acquired image data of each mail piece; and
a user interface for enabling user control of the processor, the user interface conveying control functions and features required for the generation of a permit mailing,
wherein the processor is adapted to generate a postal authority mailing report conveying data associated with each mail piece included in the mailing, the conveyed data based at least in part on an interpretation of the image data.

2. The system of claim 1 wherein the image capturing device is operatively connected to the processor.

3. The system of claim 1 wherein the image capturing device is network connected to the processor.

4. The system of claim 1 wherein the processor is capable of communicating with multiple verifying systems via a shared communication channel.

5. The system of claim 1 wherein the user interface includes an operator work station.

6. The system of claim 1 wherein the report is generated in electronic or hardcopy format.

7. The system of claim 1 further comprising a printer device for placing indicia on each mail piece.

8. The system of claim 1 wherein the weight category data is provided by a scale operating in connection with the document processing system.

9. The system of claim 1 further comprising an interface to the document processing system, wherein said document processing system includes an inserter device.

10. A method of verifying an amount of postage to be applied to one or more mail pieces in the absence of a postage meter, the method comprising the steps of:
capturing image data for the one or more mail pieces as the one or more mail pieces is processed by a document processing system;
associating weight category data with the image data captured from the one or more mail pieces; and
generating a mail report, the report conveying at least information usable by a postal authority for verifying a postage amount due as a result of processing of the one or more mail pieces, the verification based at least in part on an interpretation of the image data and the associated weight category data.

11. The method of claim 10 wherein the weight category data is received via an interface designed for use by a postage meter.

12. A method for processing one or more mail pieces comprising the steps of:
applying indicia to the one or more mail pieces as it is processed by a document processing system;
capturing image data for the one or more mail pieces as the one or more mail pieces are processed by the document processing system;
associating weight category data with the image data captured for the one or more mail pieces; and
conveying information extracted from the captured image data for the one or more mail pieces and the respective associated weight category data corresponding to the one or more mail pieces processed by the document processing system.

13. The method of claim 12, further comprising:
correlating a mail piece identifier with the mail piece, wherein the mail piece identifier is at least one of a barcode, zip code or sequence number.

14. The method of claim 13, wherein the mail piece identifier is associated with mail piece data, the mail piece data including at least one of a zip code, weight data, postage due information, quality data or postal authority data.

15. The method of claim 12, wherein the step of verifying includes generating a report conveying at least information usable by a postal authority for verifying a postage amount due as a result of processing the mail piece, the verification being based at least in part on an interpretation of the image data and the associated weight category data.

16. The method of claim 15, wherein the interpretation is performed with respect to the mail piece data, the mail piece data including at least one of a zip code, weight data, postage due information, quality data or postal authority data.

17. A method for generating a mail report comprising the steps of:
capturing image data associated with one or more mail pieces as the mail piece is processed by a document processing system;
associating weight category data with the image data captured for the mail piece;
generating a mail report conveying data including at least the associated weight category and a postage amount due for a mail piece with respect to a mail piece identifier associated with the mail piece; and
providing the mail report to the postal authority or operator of the document processing system.

18. The method of claim 17, wherein the mail report is an audit report conveying individual mail piece data for each mail piece.

19. The method of claim 18, wherein the mail report is an audit report updated with standard postal authority report information.

20. The method of claim 19, wherein the postal authority report information includes at least one of a postage summary data for conveying postage due information for the mail piece and mail qualification data for conveying the level of compliance of the mail piece data with predefined postal authority rules.

21. The method of claim 17, wherein the mail report is provided in electronic or hardcopy format.

22. A method for generating reports based on the processing of a plurality of mail pieces by a plurality of document processing devices, the plurality of mail pieces being part of a complete mailing, the method comprising the steps of:
capturing image data associated with each of the plurality of mail pieces as each mail piece is processed by a respective document processing system;
associating weight category data with the image data captured for each of the plurality of mail pieces;
generating in association with each respective document processing system a mail report conveying data including at least the associated weight category and a postage amount due for each of the plurality of mail pieces with respect to a mail piece identifier associated with each of the plurality of mail pieces; and
aggregating each respective mail report to create a final mail report, the final mail report conveying data representative of the complete mailing.

23. The method of claim 22, further comprising the step of:
providing a plurality of interfaces to the plurality of document processing devices.

24. The method of claim 22, wherein the weight category data includes measured weight or computer estimated weight.

25. The system of claim 1 wherein the weight category data includes measured weight or computer estimated weight.

26. The method of claim 10, wherein the weight category data includes measured weight or computer estimated weight.

27. The method of claim 12, wherein the weight category data includes measured weight or computer estimated weight.

28. The method of claim 17, wherein the weight category data includes measured weight or computer estimated weight.
